(19) United States
(12) Patent Application Publication
(10) Pub. No.: US 2011/0239287 A1
(43) Pub. Date: Sep. 29, 2011

(54) METHOD FOR SHARING CONTENT

(75) Inventors: Koo Yong Pak, Seoul (KR); Sung Hyun Cho, Seoul (KR); Il Gon Park, Seoul (KR); Man Soo Jeong, Seoul (KR); Kumar K. Kiran, Seoul (KR); Soo Jung Kim, Seoul (KR); Min Gyu Chung, Seoul (KR)

(73) Assignee: LG Electronics Inc., Seoul (KR)

(21) Appl. No.: 12/671,524

(22) PCT Filed: Aug. 4, 2008
(86) PCT No.: PCT/KR08/04503

§ 371 Date: Feb. 1, 2010

Related U.S. Application Data
(60) Provisional application No. 60/955,125, filed on Aug. 10, 2007.
(60) Provisional application No. 60/957,708, filed on Aug. 23, 2007.
(60) Provisional application No. 60/971,548, filed on Sep. 11, 2007.
(60) Provisional application No. 60/981,815, filed on Oct. 22, 2007.
(60) Provisional application No. 60/981,816, filed on Oct. 22, 2007.

(51) Int. Cl. H04L 9/32; G06F 21/00; G06F 15/16

(52) U.S. Cl. 726/10

(57) ABSTRACT

Disclosed is a method of sharing content. According to the content sharing method, content is received from a service provider using a receive device. A content protection solution supported in a target device is detected. The content is converted so that it is compatible with a content protection solution supported in any one of the target device and the receive device on the basis of the detected content protection solution. The receive device can include a security solution level, indicating a security characteristic of the receive device, in a certificate of the receive device. Accordingly, content transmitted from a service provider using a receive device can be shared efficiently by redistributing the content in such a way as to be compatible with a security solution of a home device.

### TECHNICAL FIELD

The present invention relates to a method of sharing content, and more particularly, to content sharing techniques in which content can be shared by redistributing content, provided from a service provider, into a home device using an IPTV receive device.

### BACKGROUND ART

In recent years, digital TV services employing wired or wireless communication networks have become generalized. The digital TV services can provide a variety of services that could not be provided in existing analog broadcasting services. For example, an IPTV (Internet Protocol Television) service being a kind of the digital TV services provides interactivity in which a user can actively select the type of an audience program, the audience time, etc. The IPTV service can provide a variety of supplementary services, for example, Internet search, home shopping, on-line game and the like on the basis of this interactivity.

For this IPTV service, a user side must be provided with an IPTV set-top box. The IPTV set-top box has to have software, supporting interactive services, installed therein and can perform functions as a service client based on the software. For example, the IPTV set-top box can request a service provider to transmit broadcasting content while transmitting/receiving information to/from the service provider over an IP network, convert a broadcasting signal, which is received from the service provider, into a standard TV signal, and transmit the signal to a TV receiver.

Meanwhile, attempts have recently been made to expand the providing area of IPTV content while associating the IPTV services with home network environment within a home. For example, there is a content sharing service. The content sharing service operatively associates an IPTV set-top box, that is, an IPTV compatible terminal with devices connected to a home network and redistributes content, stored in the IPTV set-top box, into the operatively associated devices. Accordingly, the content sharing service enables IPTV content to be played in various devices desired by users.

One of the most important keys in implementing a system for this content sharing service is to safely protect content from illegal behaviors, which may happen when storing or redistributing the content, for example, illegal leakage, copy, etc. of the content. Accordingly, security means and procedures for protecting content are indispensably required in the content sharing service and therefore there is an urgent need for the development of pertinent techniques according to this request.

### DISCLOSURE OF INVENTION

### Technical Problem

Accordingly, the present invention has been made in view of the above problems, and it is an object of the present invention to provide a method of sharing content, which can associate security solution levels with devices and redistribute content based on security information of the devices.

### Technical Solution

To achieve the above object, an aspect of the present invention provides a method of sharing content. The method of sharing content includes the steps of receiving content from a service provider, detecting a target content protection solution supported in a target device, and converting the content in such a way as to be compatible with a content protection solution supported in any one of the target device and the receive device on the basis of the detected content protection solution. The receive device can include a security solution level, indicating a security characteristic of the receive device, in a certificate of the receive device.

The security solution level is classified according to security characteristic information of a security solution authentication process of the receive device. The security solution level can be classified into a number of levels on the basis of the security solution authentication process or authentication and integrity checks using a software or hardware element. The higher is the security of the security solution authentication process, the higher level is assigned to the security solution level.

The conversion step can include the steps of, when the target content protection solution supported in the target device is identical to a content protection solution supported in the receive device, converting the content in such a way as to be compatible with the content protection solution supported in the receive device, and when the target content protection solution supported in the target device is different the content protection solution supported in the receive device, converting the content in such a way as to be compatible with the target content protection solution.

The step of receiving the content from the service provider can include the step of receiving the content, transmitted from the service provider, using any one of a service protection solution and the content protection solution. Further, the content sharing method can further include the step of redistributing the converted content into the target device.

A security solution level, indicating a security characteristic of a home device, can also be included in a certificate of the home device. Transmission of the content to the home device can be restricted on the basis of the security solution level of the receive device or the security solution level of the home device.

### Advantageous Effects

As described above, in accordance with the present invention, content can be shared efficiently by redistributing the content, which is transmitted from a service provider, in such a way as to be compatible with a security solution of a home device using a receive device. Further, a security solution level, indicating the security characteristic of a corresponding device, can be associated with a device, for example, a receive device or a home device, and transmission of content can be controlled based on the security solution level.

### BRIEF DESCRIPTION OF THE DRAWINGS

FIG. 1 is a block diagram showing the configuration of a domain system for a method of sharing content in accordance with a preferred embodiment of the present invention;

FIG. 2 is a block diagram schematically showing an overall configuration of a system for realizing the method of sharing content;

FIG. 3 is a block diagram showing the construction of an IPTV receive device shown in FIG. 2;

FIG. 4 is an exemplary view showing a security solution level table, being a criterion to designate the security solution level of a device;

FIG. 5 is an exemplary view showing the procedure of a method of storing content in accordance with a preferred embodiment of the present invention;

FIG. 6 is a block diagram showing a system configuration for realizing the method of sharing content in accordance with a preferred embodiment of the present invention;

FIG. 7 is a flowchart illustrating the method of sharing content in accordance with a preferred embodiment of the present invention;

FIG. 8 is a block diagram showing a system configuration for realizing a method of sharing content in accordance with another preferred embodiment of the present invention a method of sharing content;

FIG. 9 is a flowchart illustrating the method of sharing content in accordance with another preferred embodiment of the present invention;

FIG. 10 is an exemplary view illustrating a concept of a content association service between service providers;

FIG. 11 is an exemplary view illustrating a system configuration for a content association service between service providers; and

FIG. 12 is an exemplary view illustrating a procedure of a content association service between service providers.

### DESCRIPTION OF REFERENCE NUMERALS OF PRINCIPAL ELEMENTS IN THE DRAWINGS

20: service provider
40: IPTV receive device
44: service protection solution
45a: content protection solution ‘A’ of IPTV receive device
50: home device
55a: content protection solution ‘A’ of home device

### MODE FOR THE INVENTION

Hereinafter, the present invention will be described in detail in connection with preferred embodiments with reference to the accompanying drawings in order for those skilled in the art to be able to implement the invention. In the preferred embodiments of the present invention, specific technical terminologies are used for clarity of the content. However, It is to be understood that the present invention is not limited to specific selected terminologies and each specific terminology includes all technical synonyms operating in a similar way in order to accomplish a similar object.

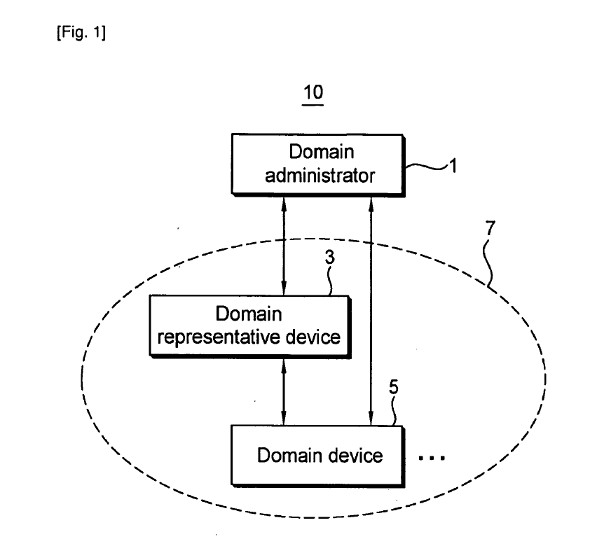

FIG. 1 is a block diagram showing the configuration of a domain system for a method of sharing content in accordance with a preferred embodiment of the present invention.

As shown in FIG. 1, a domain system 10 configures a domain 7. The domain 7 is a collection of domain devices 5, i.e., authorized devices and can refer to a range to which a domain service applies. Content can be shared and used between the domain devices 5 included in the domain 7 according to authorized rights.

The domain 7 can be configured in consideration of the physical location of devices. That is, the domain 7 is configured according to devices existing within a specific physical area. In order to configure this domain 7, local environment is needed. Here, local environment can refer to an environment in which a physical network over which devices belonging to a specific local area can associate with one another is provided and the physical network can also associate with an external network.

As an example in which this local environment can be provided, there can be a home network system. The home network system enables home appliances, various sensors, security devices, etc. within a home to associate with one another over a wired or wireless local network and can also operate in conjunction with an external network, such as Internet, over a communication node such as a home gateway. The local environment can be configured if not only this home network system, but also two or more network devices, which can operate in conjunction with one another, exist.

An area in which this local environment is provided is hereinafter referred to as a domain area. A number of devices can exist within the domain area. A user can configure the domain 7 using the devices, and the domain devices 5 can share and use content. For registration with the domain 7, a device transmits a domain registration request to a domain administrator 1. The domain administrator 1 that has received the request determines whether the domain registration request is legitimate, and so on and registers the device with the domain 7. The domain devices 5 registered with the domain 7 can share and use content according to authorized condition. Meanwhile, devices outside a domain area, for example, devices in external areas, which are connected over an Internet, etc., can also be registered with the domain in a remote state, if appropriate.

Meanwhile, the domain 7 can include a domain representative device 3. The domain representative device 3 can refer to a device functioning as a master for managing a domain within the domain. For example, the domain representative device 3 can help the domain administrator 1 in order to perform a domain administration function, a domain device administration function, a domain device authentication function and so on. Further, the domain representative device may also verify whether a corresponding device is included within a domain area by measuring the proximity of a corresponding device within the domain area. In other words, the domain representative device 3 can perform a function of deciding a physical (for example, the number of hops, the reaction time, TTL, etc.) range of the domain 7. Proximity measurement information can be used as information capable of determining whether a corresponding domain device 5 can be authorized in the domain administrator 1 when registering the domain device 5 with the domain and information for administrating whether the domain device 5 is in a local access state (that is, a state where the domain device 5 accesses the domain within the domain area) or in a remote access state (that is, a state where the domain device 5 accesses the domain outside the domain area).

This domain representative device 3 can be selected from domain devices at a specific point of time (for example, when a domain is first configured), when a user makes a request, when error occurs in an existing domain representative device) or the like. For example, a domain device having the highest device capability (for example, a device that finally survives in election competition) can be selected as the domain representative device 3 through the election competition in which devices with a high device capability survive, but devices with a low device capability are left through comparison of device capabilities while the domain devices transmit and receive device capability information, or the domain devices transmit device capability information to the domain administrator 1 or a specific device and the domain administrator 1 or the specific device, which has received the device capability information, elects a domain device with the highest device capability as the domain representative device 3.

The device capability can refer to a hardware or software capability of a corresponding device (for example, the battery capacity, a hardware specification, the type of software, whether specific software is mounted and so on). Meanwhile, an elected domain device is designated as the domain representative device 3 and performs the above-mentioned functions.

The configuration of the domain system has been so far. If the concept of this domain applies to an IPTV service system, a content sharing system in which IPTV service content can be shared and used in a plurality of devices can be configured.

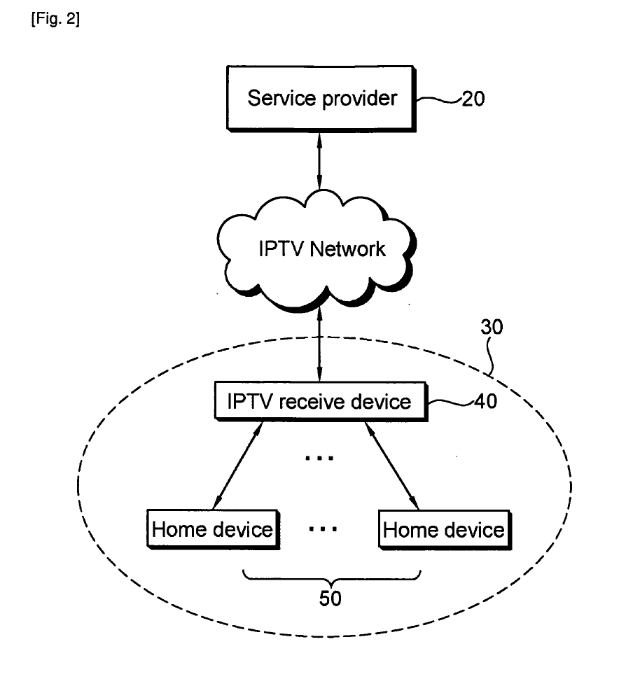

FIG. 2 is a block diagram schematically showing an overall configuration of a system for realizing the method of sharing content.

As shown in FIG. 2, an IPTV receive device 40 can operate in conjunction with a service provider 20 over an IP communication network. At this time, the IPTV receive device 40 can refer to a terminal equipped with the IPTV service function, for example, an IPTV set-top box or the like. The IPTV receive device 40 may be a domain representative device. This MTV receive device 40 may also operate in conjunction with home devices 50. At this time, the home devices 50 can include fixed or portable terminals equipped with wired or wireless network functions, for example, home appliances, mobile phones, personal computers (PC), notebook, personal digital assistance (PDA), portable multimedia player (PMP), a remote controller and so on.

The IPTV receive device 40 and the home device 50 can join a domain 30 in order to share content. That is, the IPTV receive device 40 and the home device 50 can be domain devices. In order to join the domain, the IPTV receive device 40 and the home device 50 can request joining to the domain 30 from each service provider 20, and the service provider 20 can authorize the corresponding devices 40 and 50 and issue a certificate to the devices, and register the devices 40 and 50 with the domain 30.

When requesting registration with the domain 30, the IPTV receive device 40 or the home device 50 can provide its own security capability information to the service provider 20. At this time, the security capability information can include information of security solutions (for example, a conditional access system (CAS) module, a digital rights management (DRM) module, etc.), which apply to corresponding devices, security solution levels and so on. The security solution level can refer to security solution profile information, indicating the security level of a security solution authentication process applied to a device. Preferably, the security solution level can refer to information in which the security level of the security solution authentication process is classified on the basis of a table. This security solution level will be described in detail later on.

The service provider 20 can store security capability information received from the IPTV receive device 40 or the home device 50 and can insert at least one of several pieces of security capability information (for example, information of security solutions, security solution levels, etc.) into the certificates of the devices 40 and 50 and issue the certificates to the devices 40 and 50.

Meanwhile, the IPTV receive device 40 can request content guidance information from the service provider 20 and receive the content guidance information from the service provider 20. At this time, the content guidance information is information to guide the schedule, list, supplementary information, etc. of service content and can be, for example, electronic program guide (EPG), content program guide (CPG), VoD content guide, interactive program guide (IPG) and so on.

The IPTV receive device 40 can process the content guidance information, received from the service provider 20, in such a way as to be compatible with a user interface and display the processed content guidance information. A user can select a desired service content from the displayed content guidance information. In response thereto, the IPTV receive device 40 can request the selected content from the service provider 20.

In response to the request of the IPTV receive device 40, the service provider 20 transmits the corresponding content to the IPTV receive device 40. At this time, the service provider 20 can transmit content-related information necessary to use the content, for example, security information, usage rights information, revocation list information, etc. to the IPTV receive device 40 along with the content. The security information can include a security level in which content can be used or shared, security solution information necessary to use content and so on. The usage rights information can include rights information for using content, for example, the license of content and the like. The revocation list information can include a revocation list, that is, a list of devices, which are prevented to use content, or information to identify the revocation list.

The IPTV receive device 40 can receive, store and play content, which is transmitted from the service provider 20, and can transmit the content to the home devices 50 registered with the domain 30. In order to perform storage, play, transmission, etc. of content, pieces of information associated with content transferred from the service provider 20, for example, the security information, the usage rights information, the revocation list information and so on can be taken into consideration, and storage, play or transmission of the content can be limited on the basis of the pieces of information.

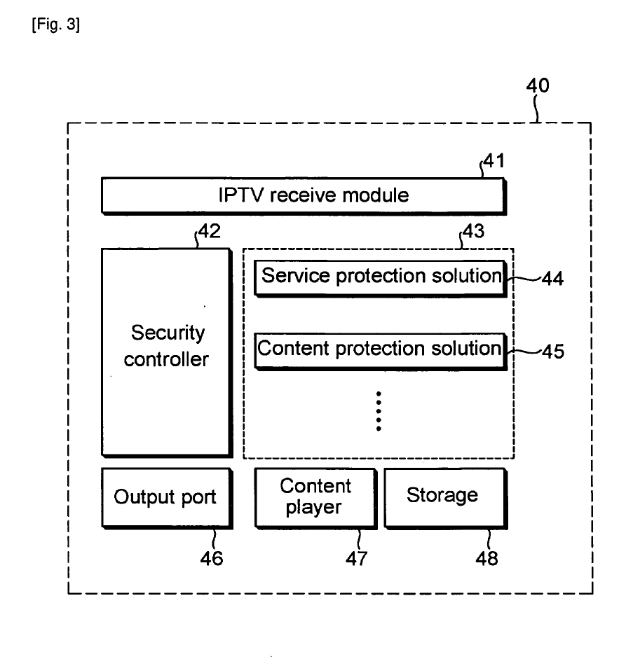

FIG. 3 is a block diagram showing the construction of the IPTV receive device 40 shown in FIG. 2.

As shown in FIG. 3, the IPTV receive device 40 can include an IPTV receive module 41, a security controller 42, a security solution 43, a content player 47, a storage 48, an output port 46 and so on. Although not shown, the IPTV receive device 40 can also include function modules included in a typical IPTV terminal, for example, an information input module, a display module, a power source module and so on. They are elements not directly associated with the gist of the present invention, and additional figures and description thereof are omitted.

The IPTV receive module 41 can perform an interface function of transmitting/receiving data to/from the service provider 20. For example, the IPTV receive module 41 can receive content and pieces of information, which is necessary to use the content, such as the security information, the usage rights information, and the revocation list information, from the service provider 20. The content can be scrambled or encrypted according to a specific protection technology, for example, a service protection technology or a content protection technology such as the conditional access system (CAS) or the digital rights management (DRM). Meanwhile, the IPTV receive module 41 can receive data, which is pertinent to the security solution 43, such as DRM codes, security messages, and applications, from the service provider 20 or a specific server. The IPTV receive device can receive the data in the form of a transport stream (TS) or secure download.

The security controller 42 can perform a security control function for content and device security. For example, the security controller 42 can request the service provider 20 to register the IPTV receive device 40 with a domain and can receive and store a certificate, evidencing that the domain has been registered. At the time of the domain registration request, the security controller 42 can check the security solution 43 included in the IPTV receive device 40 and provide information of a security solution (for example, the CAS module, the DRM module, etc.), which has been applied to the IPTV receive device 40, to the service provider 20 and can also provide a security solution level of the IPTV receive device 40 to the service provider 20.

The security controller 42 can control the IPTV receive module 41 to receive content and content pertinent information, which is necessary to use the content, from the service provider 20, and controls the security solution 43, for example, a service protection solution 44 to convert scrambled content into content of a clean type. Furthermore, the security controller 42 controls the security solution 43, for example, a content protection solution 45 to convert content, which has been converted in a clean type, and the usage rights information of the content into a form, which can be supported in the content player 47, and controls the storage 48 to store the converted content or the content player 47 to play the content.

Further, in the case in which there is a content sharing request of a user from the home device 50, the security controller 42 can detect which content protection solution is applied to the home device 50, convert the content to a form that is supported by a corresponding content protection solution, and transmit the converted content to the home device 50 through the output port 46. At this time, if the detected content protection solution (not shown) of the home device 50 is identical to the content protection solution 45 of the IPTV receive device 40, the security controller 42 can transmit the content, which has been converted into the form that can be supported in the content protection solution 45 of the IPTV receive device 40, to the home device 50 without additional conversion.

Meanwhile, the security controller 42 can restrict the sharing of content on the basis of the security solution level of the IPTV receive device 40 or the security solution level of the home device 50. For example, the security controller 42 can check security information associated with content, extract a security level necessary to transmit the content, check the security level of the IPTV receive device 40 or the home device 50 in the security solution level of the IPTV receive device 40 or the home device 50 and, when the security level necessary to use the content does not satisfy the security level of the IPTV receive device 40 or the home device 50, restrict the use or transmission of the content.

The security solution 43 can perform a function of protecting content under the control of the security controller 42. The security solution 43 can include the service protection solution 44, the content protection solution 45 and so on.

The service protection solution 44 can refer to a module that performs a function of applying service protection technology to content or releasing the application of the service protection technology. The service protection solution 44 can be the CAS solution and so on. The service protection module 44 receives and processes content transmitted from the service provider 20 under the control of the security controller 42. For example, the service protection solution 44 can extract a descrambling key from a TS received from the service provider 20, descramble scrambled and received content using the descrambling key, and convert the descrambled content into content of a clean type.

The content protection solution 45 can refer to a module that performs a function of applying content protection technology to content or releasing the application of the content protection technology. The content protection module 45 can be a DRM module, a copy protection module, an authorized service domain (ASD) module or the like. The content protection solution 45 can convert content under the control of the security controller 42. For example, the content protection solution 45 can encrypt content according to the DRM technology in order to store the content or redistribute the content into the home device 50, or descrypt encrypted content for the purpose of play, etc. Meanwhile, the service provider 20 can transmit content to the IPTV receive device 40 by applying the content protection technology to the content. In this case, the content protection solution 45 can receive, store or process content in accordance with a concept such as the above-described function of the service protection solution 44.

The content player 47 can perform a function of playing content, for example, multimedia, etc. For example, the content player 47 can perform a function of receiving and playing content converted by the security solution 43 at the request of a user. For example, the content player 47 can play content, which is converted by the content protection solution 45, while operating in conjunction with the content protection solution 45. The storage 48 can store content processed by the security solution 43. The output port 46 performs a function of operating in conjunction with the home device 50. For example, the output port 46 can perform a function of transmitting content to the home device 50 under the control of the security controller 42.

The construction of the IPTV receive device 40 has been described so far. Meanwhile, although not shown in the drawings, the home device 50 can have almost the same construction as that of the IPTV receive device 40 except for constructions, which are necessary to directly operate in conjunction with the service provider 20, for example, the IPTV receive module 41, the service protection solution 44 or the like. However, this is not a limiting factor, and the home device 50 may directly operate in conjunction with the service provider 20. This home device 50 may also transmit content to another home device.

Meanwhile, a device, for example, the IPTV receive device 40 or the home device 50 can perform a security solution authentication process of authenticating DRM codes, security messages, applications, etc. for a security solution when downloading or receiving them from the service provider 20 or a specific server. The security solution authentication process has an effect on reliability when performing the security function of the security solution. That is, the more strict is the security solution authentication process, the higher is the reliability of the security solution. The concept of a security solution level can be introduced as information indicating the security level of the security solution authentication process.

The security solution level can refer to classified information in which the security characteristic of a device is classified according to predetermined criterion. The security solution level can be a security solution profile of a device. A device can be associated with a security solution level, which is assigned according to the security level of a security solution authentication process of the device. The predetermined criterion can be a security solution level table.

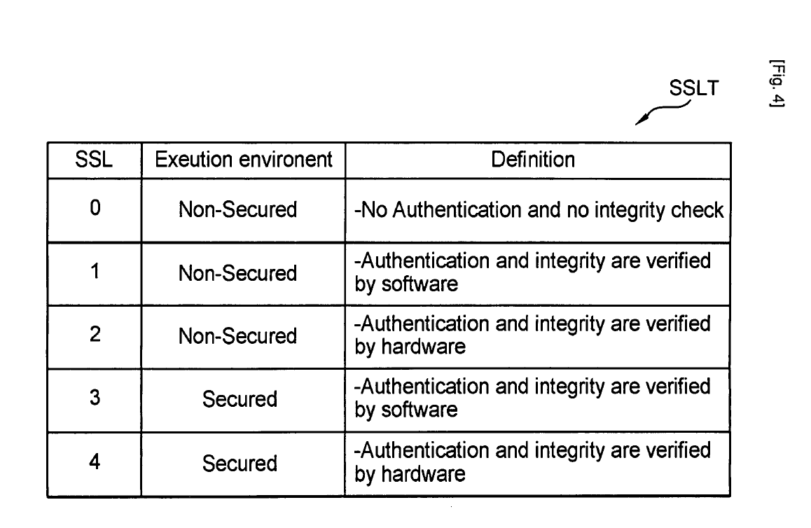

FIG. 4 is an exemplary view showing the security solution level table, being a criterion to designate the security solution level of a device.

As shown in FIG. 4, the security solution level table (SSLT) can define five grades of the security solution level as an example.

The level 0 can refer to a security level in which authentication and integrity checks of a security solution authentication process are not carried out in non-secured execution environment. A device with the security solution level of the level 0 does not experience the security solution authentication process and initiates the security solution authentication process. Accordingly, if the security solution level of a device is the level 0, it can be said that the security of the device is very vulnerable. The level 0 is a level with the lowest reliability, of the defined security solution levels.

The level 1 can refer to a security solution level in which authentication and integrity checks of a security solution authentication process are verified using a software element of a device in non-secured execution environment. The security solution authentication process in the level 1 can be initiated after being authenticated by a software element of a device. It can be said that the level 1 has security higher than that of the above level 0.

The level 2 can refer to a security solution level in which authentication and integrity checks of a security solution authentication process are directly verified using a hardware element of a device in non-secured execution environment. The security solution authentication process in the level 2 can be initiated after being authenticated by a hardware element of a device. It can be said that the level 2 has security higher than that of the above level 1.

The level 3 can refer to a security solution level in which authentication and integrity checks of a security solution authentication process are verified using a software element of a device in secured execution environment. The security solution authentication process in the level 3 can be initiated after being authenticated by a software element of a device under secured execution environment. It can be said that the level 3 has security higher than that of the above level 2.

The level 4 can refer to a security solution level in which authentication and integrity checks of a security solution authentication process are directly verified using a hardware element of a device in secured execution environment. The security solution authentication process in the level 4 can be initiated after being authenticated by a hardware element of a device under secured execution environment. It can be said that the level 4 has security higher than that of the above level 3 and has the highest reliability of the defined security solution levels.

A device, for example, the IPTV receive device 40 or the home device 50 can have a security solution level corresponding to the above criterion according to a security level of the corresponding device. The security solution level can be inserted into a specific field within a certificate of a device and associated with the corresponding device. That is, the certificate of the device can include a security solution level of the device.

A device can restrict use or transmission of content on the basis of its own security solution level or a security solution level of a device, that is, a target device with whom content will be shared. For example, in the case in which a security level required to use or share content does not fulfill its own security level or a security level of a target device (that is, a security solution level of a corresponding device), use or sharing of the content may be restricted. Information pertinent to a security level required in content can be included in security information associated with content. The security information associated with the content can include information, indicating a security solution level required when using or sharing the corresponding content.

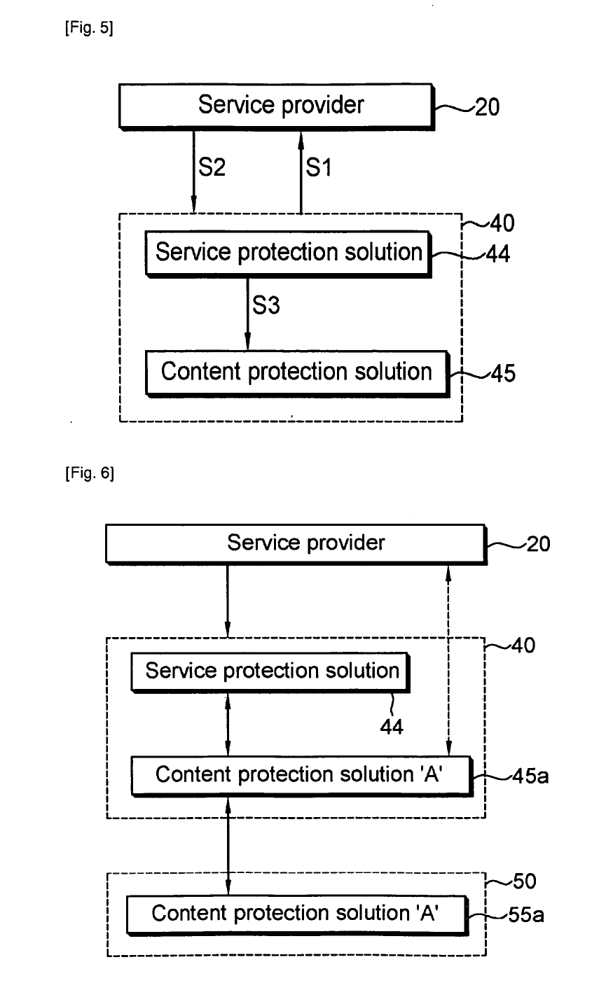

FIG. 5 is an exemplary view showing the procedure of a method of storing content in accordance with a preferred embodiment of the present invention. This drawing illustrates a process in which the IPTV receive device 40 receives content from the service provider 20 and stores the received content.

As shown in FIG. 5, the IPTV receive device 40 is equipped with the service protection solution 44 and the content protection solution 45. First, a user can request the IPTV receive device 40 to download and store content in order to watch the content. In response thereto, the IPTV receive device 40 requests the service provider 20 to transmit the corresponding content (step: S1). Meanwhile, a user may also request transmission of content to the IPTV receive device 40 through another device (for example, a home device, or a third terminal).

The service provider 20 protects the content using a service protection solution of the service provider 20 and transmits the protected content to the IPTV receive device 40. For example, the service provider 20 can scramble the content using the service protection solution and transmit the scrambled content, usage rights information, etc., which are associated with the content, to the IPTV receive device 40.

The IPTV receive device 40 downloads the content, which is transmitted from the service provider 20, using the service protection solution 44 included in the IPTV receive device 40 (step: S2). Upon downloading, the service protection solution 44 of the IPTV receive device 40 can convert the scrambled content, which is received from the service provider 20, into content that can be processed therein, for example, content of a clean type.

Next, the content protection solution 45 of the IPTV receive device 40 can convert the downloaded content in such a way as to be compatible with the content protection solution 45 that supports a content player and store the converted content in the storage (step: S3). Further, the content protection solution 45 of the IPTV receive device 40 can convert usage rights information, etc., which are associated with the content, into a form compatible with the content protection solution 45 and store the converted content. Meanwhile, when using the content, the use of the content can be restricted according to a security solution level of the IPTV receive device 40.

As described above, the IPTV receive device 40 can download content, which is transmitted from the service provider 20, using the service protection solution 44 included in the IPTV receive device 40 and convert the content into content of a type, which can be secured and played in the IPTV receive device 40, using the content protection solution 45.

Meanwhile, although not shown, as another embodiment of the method of storing content, the service provider 20 may protect content in such a way as to be compatible with the content protection solution 45 included in the IPTV receive device 40 and transmit the protected content to the IPTV receive device 40. For example, when the IPTV receive device 40 requests transmission of content, the service provider 20 can protect the content using a content protection technique so that the content is compatible with the content protection solution 45 supported in the IPTV receive device 40 and transmit the protected content to the IPTV receive device 40. Thus, the content protection solution 45 of the IPTV receive device 40 can receive and store the content.

When the IPTV receive device 40 is registered with a domain, the service provider 20 can receive security capability information of the IPTV receive device 40 from the IPTV receive device 40 at the request of the service provider 20, and store and manage the received security capability information of the IPTV receive device 40. Accordingly, the service provider 20 can know the content protection solution 45 of the IPTV receive device 40. The security capability information can include, as mentioned earlier, information of a security solution, a security solution level, etc., which are included in the IPTV receive device 40. The information of the security solution, the security solution level and so on may also be included in a certificate of the IPTV receive device 40.

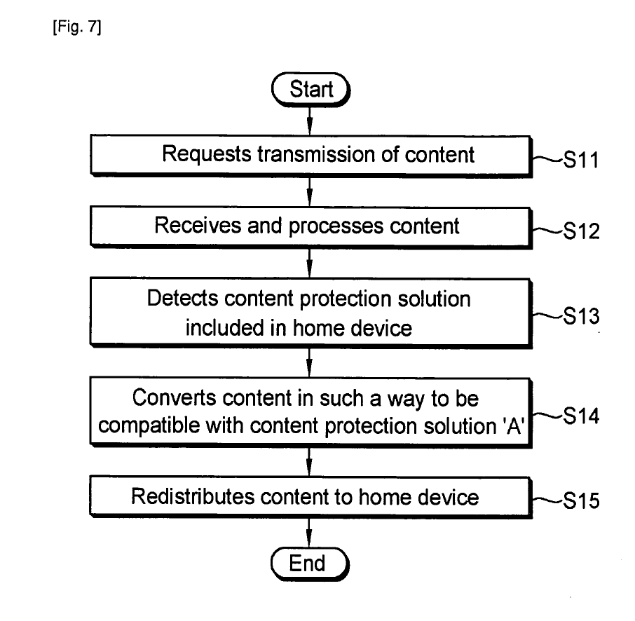

FIG. 6 is a block diagram showing a system configuration for realizing the method of sharing content in accordance with a preferred embodiment of the present invention. FIG. 7 is a flowchart illustrating the method of sharing content in accordance with a preferred embodiment of the present invention. The drawings illustrate a procedure of sharing content, which is downloaded from the service provider 20, by redistributing the content into the home device 50.

As shown in FIG. 6, the service provider 20 transmits content using a service protection technique, and the IPTV receive device 40 includes the service protection solution 44 and a content protection solution ‘A’ 45a. Further, the home device 50 that will share the content with the IPTV receive device 40 includes the same content protection solution ‘A’ 55a as the content protection solution ‘A’ 45a of the IPTV receive device 40. That is, the home device 50 supports the same content protection solution as that of the IPTV receive device 40.

Referring to FIGS. 6 and 7, first, a user can request to download desired content onto the home device 50 using the IPTV receive device 40 or the third device, which can discover the home device 50, through the home device 50 or a discovery process in order to download the content onto the home device 50 and watch the downloaded content. In response thereto, a corresponding device requests the service provider 20 to transmit the content requested by the user (step: S11).

In response to the request, the service provider 20 scrambles the content using the service protection solution of the service provider 20 and transmits the scrambled content and pieces of information, which are required to use the content, such as usage rights information, security information, and revocation list information, to the IPTV receive device 40. Accordingly, the content protected by the service protection technique is transmitted to the IPTV receive device 40.

The IPTV receive device 40 can receive the content from the service provider 20 and process the received content using the service protection solution 44 included in the IPTV receive device 40 (step: S12). For example, the service protection solution 44 can convert the received and scrambled content into content of a clean type according to a service protection technique. The service protection solution 44 may also convert the pieces of information required to use the content into a form, which can be used within the IPTV receive device 40.

Next, the IPTV receive device 40 detects the content protection solution included in the home device 50 to which the content will be sent (step: S13). At this time, if the content protection solution supported in the home device 50 is identical to the content protection solution of the IPTV receive device 40 (in the present embodiment, the home device 50 and the IPTV receive device 40 include the content protection solutions ‘A’ 55a and 45a, respectively, which support the same content protection technology), the content protection solution ‘A’ 45a of the IPTV receive device 40 convert the content into a form appropriate for the content protection solution ‘A’ 45a (step: S14). For example, the content protection solution ‘A’ 45a can encrypt the content in an engaged form and translate usage rights, etc. of the content into a form suitable for the content protection solution ‘A’ 45a.

Next, the IPTV receive device 40 redistributes the converted content by transmitting the content and pieces of information, which are required to use the content, to the home device 50 using a technology supported in the content protection solution ‘A’ 45a (step: S15). At this time, the IPTV receive device 40 can restrict the transmission of the content on the basis of the usage rights of the content. In other words, the sharing of the content can be performed within a range allowed in the usage rights associated with corresponding content.

Further, the IPTV receive device 40 may also restrict the sharing of the content on the basis of a security solution level of the home device 50 or the IPTV receive device 40. For example, the IPTV receive device 40 may restrict the sharing of the content when a security level required to share the content does not satisfy a security level of the IPTV receive device 40 or the home device 50 (that is, a security solution level of a corresponding device). At this time, the security solution level of the IPTV receive device 40 and the security solution level of the home device 50 can be included in a certificate of the IPTV receive device 40 and a certificate of the home device 50, respectively, and the security level required to share the content can be included in security information associated with the content. The IPTV receive device 40 can check its own certificate in order to confirm its own security solution level and may request the certificate from the home device 50 or separately request information of the security solution level of the home device 50 in order to confirm the security solution level of the home device 50.

On the other hand, the IPTV receive device 40 can check whether the home device 50 is a domain device registered with the same domain as that of the IPTV receive device 40 through mutual authentication with the home device 50. If, as a result of the check, the home device 50 does not belong to the same domain as that of the IPTV receive device 40, the IPTV receive device 40 can restrict content sharing to the home device 50.

When the content and the pieces of information required to use the content are transmitted from the IPTV receive device 40 to the home device 50, the content protection solution ‘A’ 55a of the home device 50 can receive, store and play the content. When the content is played, the content protection solution ‘A’ 55a of the home device 50 can decrypt encrypted content so that the content can be played within a range allowed in the usage rights information of the content and provide the decrypted content to a content player (not shown).

Meanwhile, as indicated by a dotted line in FIG. 6, the service provider 20 and the content protection solution ‘A’ 45a may directly operate in conjunction with each other. For example, the service provider 20 can protect content using a content protection technology, which is compatible with the content protection solution ‘A’ 45a included in the IPTV receive device 40, and transmit the content to the IPTV receive device 40. In this case, the IPTV receive device 40 can download the content, which has been protected by the content protection solution ‘A’ 45a, from the service provider 20 without an additional operation of the service protection solution 44 and then redistribute the content into the home device 50.

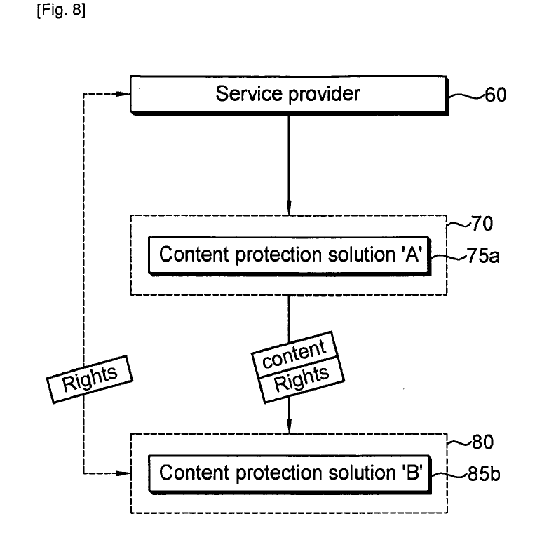

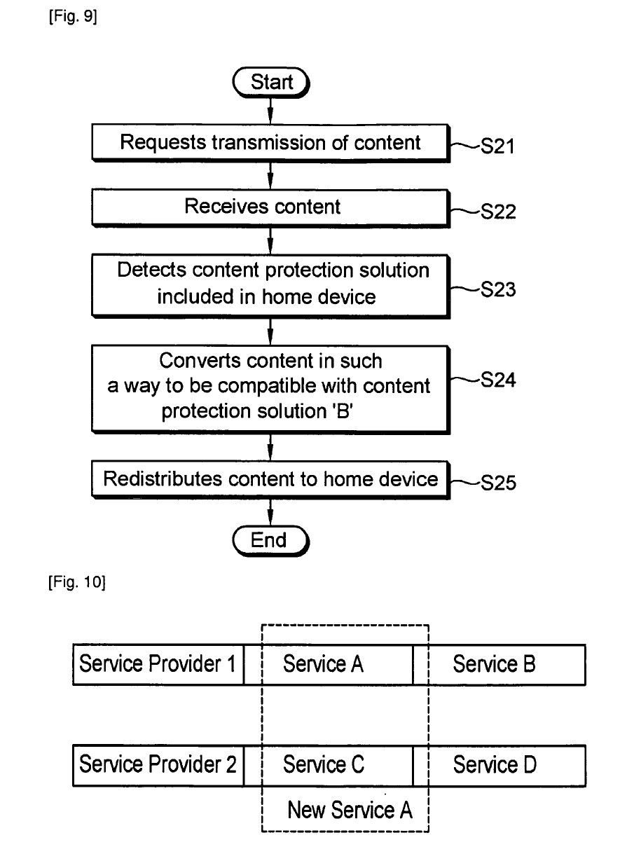

FIG. 8 is a block diagram showing a system configuration for realizing a method of sharing content in accordance with another preferred embodiment of the present invention a method of sharing content. FIG. 9 is a flowchart illustrating the method of sharing content in accordance with another preferred embodiment of the present invention. The drawings illustrate a procedure of sharing content, which is downloaded from a service provider 60, by redistributing the content into a home device 80.

As shown in FIG. 8, the service provider 60 transmits content according to a content protection technique, and an IPTV receive device 70 is equipped with a content protection solution ‘A’ 75a. Further, a home device 80 that will share the content with the IPTV receive device 70 includes a content protection solution ‘B’ 85b that supports a different kind of a content protection technology from that of the content protection solution ‘A’ 75a of the IPTV receive device 70.

Referring to FIGS. 8 and 9, first, a user can request to download desired content onto the home device 80 using the IPTV receive device 70 or a third device, which can discover the home device 80, through the home device 80 or a discovery process in order to download the content onto the home device 80 and watch the downloaded content. In response thereto, a corresponding device requests the service provider 60 to transmit the content requested by the user (step: S21).

In response to the request, the service provider 60 encrypts the content using the content protection solution A of the service provider 60 and transmits the encrypted content and pieces of information, which are required to use the content, such as usage rights information, security information, and revocation list information, to the IPTV receive device 70. Accordingly, the content protected by the content protection technique is transmitted to the IPTV receive device 70.

The IPTV receive device 70 can receive the content from the service provider 60 using the content protection solution ‘A’ 75a (step: S22). Further, the content protection solution ‘A’ 75a may convert the received and encrypted content into content of a clean type so that the received and encrypted content can be converted into another content protection solution. In addition, the pieces of information required to use the content can be converted into a form that can be used within the IPTV receive device 70.

Next, the IPTV receive device 70 detects the content protection solution included in the home device 80 to which the content will be sent (step: S23). At this time, if the content protection solution supported in the home device 80 is different from the content protection solution of the IPTV receive device 70 (the present embodiment illustrates an example in which the home device 80 and the IPTV receive device 70 support different content protection solutions), the IPTV receive device 70 converts the content into a form appropriate for the content protection solution ‘B’ 85b (step: S24). For example, the IPTV receive device 70 can encrypt the content in an engaged form and translate usage rights, etc. of the content into a form suitable for the content protection solution ‘B’ 85b.

For this process, the IPTV receive device 70 can include a DRM interoperability solution or the content protection solution ‘B’. If the solutions are not included, the IPTV receive device 70 can request a corresponding solution from the service provider 60, a DRM server, the home device 80 and so on in order to download the corresponding solution.

Next, the IPTV receive device 70 redistributes the converted content by transmitting the content and pieces of information, which are required to use the content, to the home device 80 using an interoperable redistribution technology or a technology supported in the content protection solution B 85b (step: S25). At this time, the IPTV receive device 70 can restrict the transmission of the content to the home device 80 on the basis of the usage rights of the content. In other words, the sharing of the content can be performed within a range allowed in the usage rights associated with corresponding content.

Further, the IPTV receive device 70 may also restrict the sharing of the content on the basis of a security solution level of the home device 80 or the IPTV receive device 70. For example, the IPTV receive device 70 may restrict the sharing of the content when a security level required to share the content does not satisfy a security level of the IPTV receive device 70 or the home device 80 (that is, a security solution level of a corresponding device).

At this time, the security solution level of the IPTV receive device 70 and the security solution level of the home device 80 can be included in a certificate of the IPTV receive device 70 and a certificate of the home device 80, respectively, and the security level required to share the content can be included in security information associated with the content. The IPTV receive device 70 can check its own certificate in order to confirm a security solution level of the IPTV receive device 70 and may request a certificate from the home device 80 or separately request information of the security solution level of the home device 80 in order to confirm the security solution level of the home device 80.

Furthermore, the IPTV receive device 70 may check whether the home device 80 is a domain device registered with the same domain as that of the IPTV receive device 70 through mutual authentication with the home device 80. If, as a result of the check, the home device 80 does not belong to the same domain as that of the IPTV receive device 70, the IPTV receive device 70 can restrict content sharing to the home device 80.

When the content and the pieces of information required to use the content are transmitted from the IPTV receive device 70 to the home device 80, the content protection solution ‘B’ 85b of the home device 80 can receive, store and play the content. When the content is played, the content protection solution ‘B’ of the home device 80 can decrypt the encrypted content so that the content can be played within a range allowed in the usage rights information of the content and provide the decrypted content to a content player.

Meanwhile, as indicated by a dotted line in FIG. 8, in order to provide rights information of content, the service provider 60 and the home device 80 may directly operate in conjunction with each other. For example, the IPTV receive device 70 may transmit content to the home device 80, and the home device 80 may receive rights information, which is required to use the content, directly from the service provider 60.

Hereinafter, a content association security service model between service providers is described. The content association service between service providers can refer to a service in which a user can use content provided by two or more service provider through once billing. Contents to be disclosed hereinafter can provide a configuration that secures and provides stability to this service.

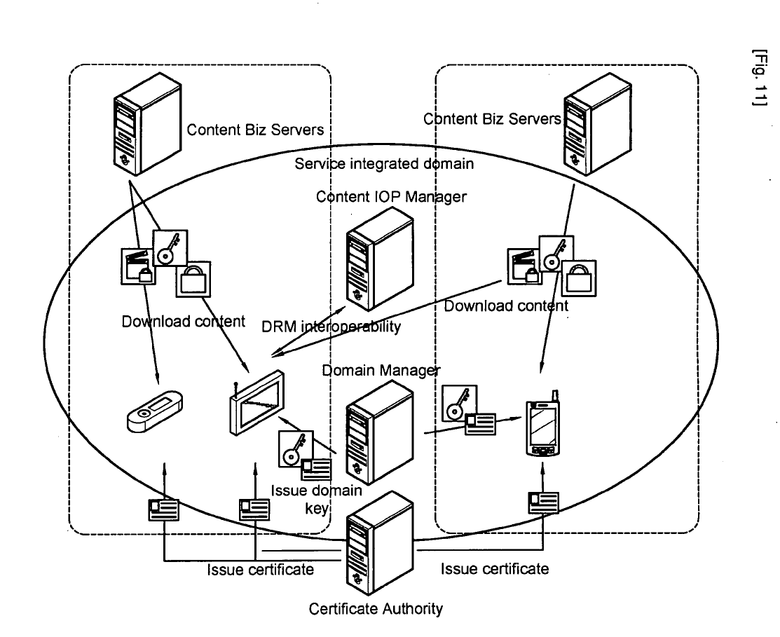

FIG. 10 is an exemplary view illustrating a concept of a content association service between service providers.

Assuming that, as shown in FIG. 10, a service provider 1 provides a service A and a service B and a service provider 2 provides a service C and a service D, in the prior art, a user can pay and use the service A and the service C, each provided by the service provider 1 and the service provider 2, through the respective service providers. However, the present invention can provide a new concept of services that freely employs ‘the service A-the service C’ through once billing.

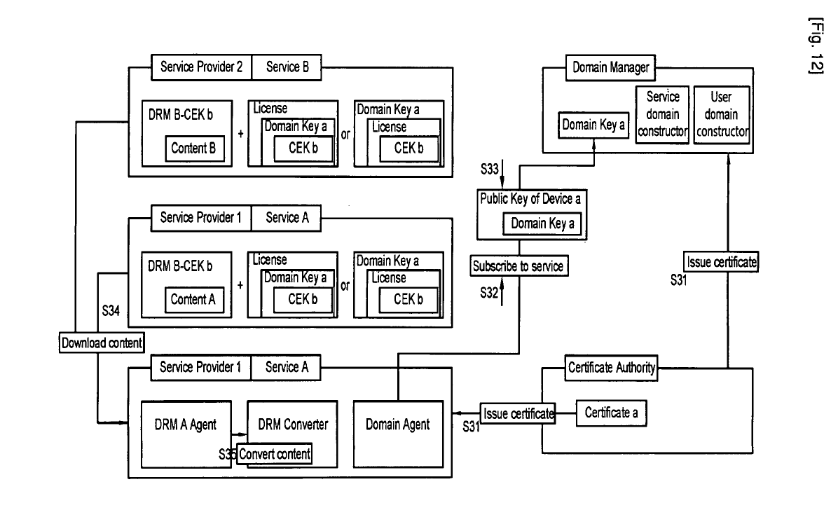

FIG. 11 is an exemplary view illustrating a system configuration for a content association service between service providers. Further, FIG. 12 is an exemplary view illustrating a procedure of a content association service between service providers.

Referring to FIGS. 11 and 12, the service provider 1 and the service provider 2 can form domains for respective services. At this time, for a content association service between the service providers, a content DRM interoperability manager, a domain manager, a certificate authority server and so on can be included.

The content DRM interoperability manager can refer to a server that provides information in order to make compatible content, which is protected by different DRMs between service providers. The domain manager can provide a service domain function of providing a service integrated domain by binding different services between service providers, which users want to receive, and a user/device domain function of binding services belonging to a service domain so that terminals of users can employ the services. The certificate authority server can refer to a server related to a content association service, a user or a server that manages certificates of user devices.

As shown in FIG. 12, a content association service between service providers first experiences a certificate issuance step (step: S31). In the certificate issuance step of the certificate authority server (step: S31), a standardized (for example, X.509 v3, etc.) certificate authority server can issue a certificate (Certificate a) for a service and transfer the certificate to a domain manager, a service provider, and a device A (Device a).

A content association service subscription step (step: S32) can refer to a step in which the device A requests the domain manager to subscribe to a service so that a user can receive a content association service through the device A.

A service domain constructor within the domain manager, which receives a request message from the device A, can bind services, requested by a user, into one virtual domain and create a domain key A (Domain key a) for protecting content belonging to the corresponding virtual domain. Further, a user domain constructor of the domain manager can configure environment in which content belonging to a virtual domain can be employed by binding devices of users (for example, a number of user devices including the device A) into the other virtual domain.

Next, a domain information providing step (step: S33) can be provided. In the domain information providing step (step: S33), the domain key A (Domain key a), the service domain information, and the user domain information created through the above content association service subscription step (step: S32) are provided, and the created information of the domain key A (Domain key a) is shared with a service provider belonging to a service domain.

In a content download step (step: S34), after subscription to the service, the user downloads content from the service provider, belonging to the service domain, onto the device A belonging to the user domain. The downloaded content is basically protected by DRM defined by each service provider, and the content protected by the DRM is protected by the domain key A (Domain key a) again and then transmitted to a user device.

Content belonging to the service domain created by the user can be protected by the same domain key A (Domain key a) although service providers differ. A protected type can include a type in which a content encryption key (CEK) used in DRM is encrypted using the domain key A (Domain key a) and stored in a license file of each DRM, and a method of encrypting the license file of each DRM using the domain key A (Domain key a) and transmitting the encrypted file to a user.

Next, a content execution and conversion step (step: S35) can be performed. The content execution and conversion step (step: S35) is a step in which a device actually owned by a user executes content downloaded in the content download step (step: S34). In this step, the device A can execute content if it has the domain key A (Domain key a) acquired in the content association service subscription step (step: S32) and an unpacking agent of DRM that protects downloaded content.

If the device A does not have the DRM unpacking agent, content can be used by performing DRM conversion through a DRM converter. However, at this time, if the domain key A (Domain key a) does not exit although conversion is performed successfully, the use of content is impossible.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method of sharing content using a receive device, the method comprising the steps of:
receiving content from a service provider;
detecting a content protection solution supported in a target device; and
converting the content in such a way as to be compatible with a content protection solution supported in any one of the target device and the receive device on the basis of the detected content protection solution,
wherein the receive device includes a security solution level, indicating a security characteristic of the receive device, in a certificate of the receive device.

2. The method of claim 1, wherein the security solution level is classified according to security characteristic information of a security solution authentication process of the receive device.

3. The method of claim 2, wherein the security solution level is classified into a number of levels on the basis of the security solution authentication process or authentication and integrity checks using a software or hardware element.

4. The method of claim 2, wherein as security of the security solution authentication process becomes higher, the security solution level is assigned a higher level.

5. The method of claim 1, wherein the conversion step includes the steps of:
when a target content protection solution supported in the target device is identical to a content protection solution supported in the receive device, converting the content in such a way as to be compatible with the content protection solution supported in the receive device; and
when the target content protection solution supported in the target device is different the content protection solution supported in the receive device,
converting the content in such a way as to be compatible with the target content protection solution.

6. The method of claim 1, wherein the step of receiving the content from the service provider includes the step of receiving the content, transmitted from the service provider, using any one of a service protection solution and the content protection solution.

7. The method of claim 1, further comprising the step of redistributing the converted content into the target device.

8. The method of claim 1, wherein a security solution level, indicating a security characteristic of a home device, is also included in a certificate of the home device.

9. The method of claim 8, wherein transmission of the content to the home device is restricted on the basis of the security solution level of the receive device or the security solution level of the home device.

10. The method of claim 1, further comprising the steps of:
converting information, which is necessary to use the content, in such a way as to be suitable for the detected content protection solution; and
transmitting the converted information to a home device.
